(19) United States
(12) Patent Application Publication
(10) Pub. No.: US 2024/0183275 A1
(43) Pub. Date: Jun. 6, 2024

(54) ROTOR OF A GAS TURBINE, AND METHOD FOR PRODUCING A ROTOR

(71) Applicant: Rolls-Royce Deutschland Ltd & Co KG, Blankenfelde-Mahlow (DE)

(72) Inventors: Sven Klaus SPANRAD, Berlin (DE); Tomasz CEREMUGA, Berlin (DE)

(21) Appl. No.: 18/488,681

(22) Filed: Oct. 17, 2023

(30) Foreign Application Priority Data
Oct. 25, 2022 (DE) 10 2022 211 305.5

(51) Int. Cl. F01D 5/14

(52) U.S. Cl. CPC F01D 5/147; F05D 2240/303; F05D 2240/80; F05D 2260/941

(57) ABSTRACT

A rotor of a gas turbine includes a rotating body with a platform with rotor blades arranged thereon, at least one turbine blade, the platform of the rotating body having first and second sections oriented at a respective angle of attack with respect to the engine longitudinal axis. The respective rotor blades are subject to crack growth in the state in which they are installed as intended into an engine, a respective crack spreading from a leading edge of the turbine blade as far as a predefined axial fracture crack length, at which blade fracture occurs. The first section has a smaller angle of attack than the second section, the first section extending from a leading edge of the platform as far as the axial fracture crack length. Moreover, the disclosure relates to a method for producing a rotor.

This application claims priority to German Patent Application 102022211305.5 filed Oct. 25, 2023, the entirety of which is incorporated by reference herein.

The present disclosure relates to a rotor of a gas turbine and to a method for producing a rotor.

The engine industry is working under intense pressure to provide new integrated designs with innovative technologies for weight minimization, for service life increase and very high reliability. It is an aim of every company to reduce costs, and to increase the product safety and reliability, in order in this way to provide the basis for marketable products.

Rotor blades of rotors are subject to high-frequency vibration excitations such as air and gas flows, mechanical vibrations of components which make contact with one another, or unbalances. When set in rotation, they convert kinetic energy of the flow medium into a rotational energy. Therefore, rotor blades are frequently subjected to considerable mechanical, static and dynamic loads. Especially in the case of a high temperature and a high rotational speed at the same time, as in a gas turbine or a steam turbine, high material loading of the blade material occurs, inter alia, as a result of corrosion, oxidation and flue gas.

As a result, cracks can form in the blade material both at a blade leading edge and at a blade trailing edge, inter alia as a result of bending vibrations in the plastic range (LCF). Here, low-cycle (LCF— low cycle fatigue) and high-cycle (HCF—high cycle fatigue) fatigue strengths overlap.

Damage can likewise be caused by foreign body action (what is known as Foreign Object Damage (FOD)), a repair of cracks in the blade leading edge region being possible only with difficulties in accordance with the current prior art. Although crack formation and crack propagation are monitored by inspections during the service intervals or by way of suitable software programs, it cannot be prevented that critical components can be damaged irreparably.

Different possibilities for avoiding and/or preventing crack propagation are known from the prior art.

EP 3 480 430 A1 provides influencing the crack propagation on a rotor blade via different material and layer thicknesses for a rotor as engine component.

In order to avoid crack propagation in a first load zone of an engine component, DE 10 2019 118 549 A1 provides that at least one spatially delimited modification region is configured with a tensile residual stress which is introduced in a defined manner, via which a crack which propagates in the engine component is conducted to and/or within a second load zone. U.S. Pat. No. 10,502,230 B2 proposes that what are known as fillet radii are machined on the airfoil rotor interaction zone.

In the case of rotors which are known from the prior art, a platform, that is to say a radially outer surface of a disc body, is configured in a rectilinear manner from a leading edge to a trailing edge and has a constant angle of attack here with respect to the engine longitudinal axis.

It is a disadvantage in the case of the known rotors that, in the case of angles of attack of the rotor platform which run in a rectilinear manner, a crack which begins from the blade leading edge can grow into the rotor disc. As a result, the rotor disc can burst, which leads to a total failure of the engine.

It is accordingly an object of the present invention to specify an improved rotor with a reduced risk of bursting of the rotor disc. The disadvantages of the prior art are at least intended to be eliminated.

To this end, the invention in a first aspect proposes a rotor of a gas turbine comprising at least one rotating body with a platform and a multiplicity of rotor blades are arranged thereon. The rotor blades have at least one turbine blade, the platform of the rotating body having a first section and a second section which are oriented at a respective angle of attack with respect to the engine longitudinal axis, and the respective rotor blades are subject to a crack growth in the state in which they are installed as intended into an engine. A respective crack propagates from a leading edge of the turbine blade as far as a predefined axial fracture crack length, at which the blade fracture occurs.

It is provided according to the invention that the first section of the platform has a smaller angle of attack than the second section of the platform, the first section extending from a leading edge of the platform as far as the axial fracture crack length. In other words, the angle of attack of the first region is of smaller configuration than the angle of attack of the second region.

It has been recognized that the crack growth is subject to different phases. Here, the crack grows horizontally in a first phase, that is to say substantially parallel to the engine longitudinal axis. In a second phase, a transition phase, the crack deviates and grows substantially parallel to the angle of attack of the platform along the rotor blade. During the crack growth, the crack stress rises at the crack leading edge until the crack stress exceeds the fracture toughness of the material, at which the crack propagation speed is as it were infinite and the crack grows suddenly as far as the trailing edge of the rotor blade, and the rotor blade is detached from the rotor in the form of a forced fracture. According to the invention, a first section of the platform is configured with a smaller angle of attack than a second section of the platform. As a result of the smaller angle of attack of the first section, the transition region between the rotor blade and the platform also has a smaller angle of attack with respect to the engine longitudinal axis. On account of the smaller angle of attack of the first section in comparison with the second section of the platform, more material and therefore time are made available to the crack before the crack reaches the transition region between the rotor blade and the platform. It is therefore provided for the transition region between the rotor blade and the platform to be kept away from the crack during the first phase of the crack growth, in which the crack propagates substantially horizontally, by the transition region being configured radially below the horizontal crack growth. Therefore, the design of the rotor body is also incorporated into the layout in the approach according to the invention.

One development of the rotor provides that the respective crack arises at a radial height of the turbine blade which is arranged radially outside a critical height, the critical height being configured such that it is free from crack growth.

By way of the provision of a critical height, at which no crack growth takes place, a minimum radial height of the rotor blade can be defined, at which a crack can begin to grow. As a result, the radial spacing from the transition region and from the platform is also defined. In this way, the rotor is designed in such a way that, in the case of a crack occurring at the minimum radial height, it has in every case occurred before the transition region into the second phase of the crack growth is reached. In this way, the radial crack propagation in the direction of the rotating body or rotor disc is counteracted. Prevention of bursting or damage of the rotor disc increases the safety in the operating state and saves costs in procurement, since the rotor disc can be configured, for example, with a smaller wall thickness, as a result of which less material has to be used.

Another refinement is characterized in that the platform is configured with a discontinuous angle of attack profile with respect to the engine longitudinal axis in such a way that the angle of attack of the first and/or the second section of the platform rises in the axial direction. As a result, the profile of the angle of attack and therefore the profile of the platform surface can already be adapted in an improved manner in the first section of the platform to the operating conditions and flow conditions of the rotor. By way of a discontinuous profile of the angle of attack, the profile of the platform can be adapted in an improved manner to the operating conditions of the rotor.

In a further proposed embodiment, the angle of attack of the first section of the platform has a value of substantially 0 degrees in the region of the leading edge. As a result, the platform is configured so as to be substantially horizontal and parallel with respect to the engine longitudinal axis. In this region, as has already been mentioned, the crack likewise grows substantially horizontally. As a result, the transition region and the platform are accordingly kept away from the crack effectively. The effect which is achieved here is that an interaction zone (Airfoil Rotor Interaction Zone) can be of decreased configuration. A crack which begins in the interaction zone would propagate into the rotating body and lead to a failure of the rotating body. As has been described, this zone is configured so as to be free from crack formation via further measures. In this way, the additional measures for the crack-free configuration can be reduced.

A further embodiment of the rotor is characterized in that the turbine blade is configured with a blade material which has a fracture toughness, at which blade failure occurs, the axial fracture crack length denoting an axial length of the turbine blade, at which the crack reaches the fracture toughness of the blade material. As a result, the axial position of the turbine blade can be defined, at which the blade failure occurs. The transition region between the turbine blade and the platform should therefore reach the radial height of the horizontal crack propagation only axially behind this axial position. This is advantageous, since more time and material are therefore made available to the crack, in order to propagate in the non-critical region of the blade, and for either fracture toughness to occur in time, that is to say before the transition region is reached, or for the crack to be deflected away from the transition region.

A further refinement is characterized in that the first section of the platform is configured substantially in the range of from 0% to 50% of the axial length of the platform. Therefore, the axial fracture crack length is also configured substantially in the region of from 0 to 50% of the axial length of the platform. In manufacturing, this region therefore defines the extent of the angle of attack in the first section and defines the region with respect to the transition into the second section with a greater angle of attack. This has a positive influence on the workload and the manufacturing costs.

The invention proposes, furthermore, that a transition radius is configured between a respective turbine blade and the platform, the transition radius having an elliptical or circular course. Here, a greater radius decreases the stresses in the radius region. A smaller radius increases the stresses in the radius region. Therefore, the crack propagation direction can be influenced in this way. This additionally has an advantageous effect on the crack propagation, since the crack is therefore rather forced to deflect, and the interaction zone (Airfoil Rotor Interaction Zone) can therefore be of additionally further decreased configuration.

It is provided, furthermore, that the transition radius is at a maximum at the leading edge of the turbine blade, and decreases with an axial length in the first section of the platform. As a result, the stress which occurs during operation at the blade leading edge is minimized, and the beginning of a crack growth is delayed. As a result, the radii can be machined in a more targeted manner in terms of manufacturing technology.

A second aspect of the invention is directed to a method for producing a rotor.

The method in accordance with the second aspect comprises the steps: providing a rotating body with a platform and a multiplicity of rotor blades arranged thereon comprising a turbine blade; calculating an axial fracture crack length of a crack in the turbine blade; determining a first section of the platform and a second section of the platform. In accordance with the second aspect of the invention, it is provided in the case of the method that an angle of attack of the first section of the platform with respect to an engine longitudinal axis is larger than an angle of attack of the second section of the platform with respect to the engine longitudinal axis, the first section extending from a leading edge of the platform as far as the axial fracture crack length.

The following step is provided in one development of the method: calculating a critical height of the rotor blade which adjoins the platform radially on the outside, the critical height defining a region which is configured such that it is free from crack growth.

The method provides that the platform is configured with a discontinuous angle of attack profile with respect to the engine longitudinal axis in such a way that the angle of attack of the platform rises from the leading edge in the axial direction as far as the axial fracture crack length.

Furthermore, the method provides that the angle of attack of the first section of the platform has a value of substantially 0 degrees in the region of the leading edge.

Furthermore, one embodiment of the method relates to the fact that the turbine blade is configured with a blade material which has a fracture toughness, at which blade failure occurs, the axial fracture crack length denoting an axial length of the turbine blade, at which the crack reaches the fracture toughness of the blade material.

A further embodiment of the invention provides that the first section of the platform is configured substantially in the region of from 0 to 50% of the axial length of the platform.

One development of the method provides that a transition radius is configured between a respective turbine blade and the platform, the transition radius having an elliptical or circular course.

The method proceeds from the fact that the radius is at a maximum at a turbine blade leading edge, and decreases with an axial length in the first section of the platform.

In the following text, the invention will be illustrated by way of example on the basis of design variants with the use of the appended drawings, in which:

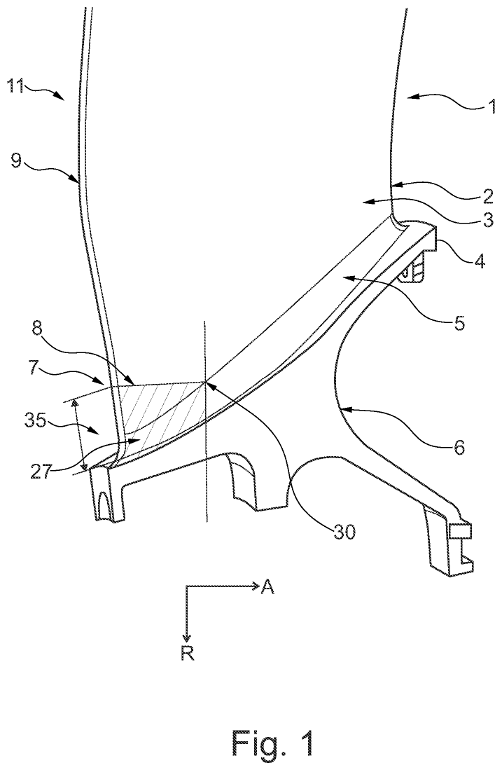

FIG. 1 shows a perspective view of a rotor blade according to the current prior art with a view of an individual rotor blade of a plurality of identically configured rotor blades, with illustration of a crack which begins at the blade leading edge and propagates in the axial direction,

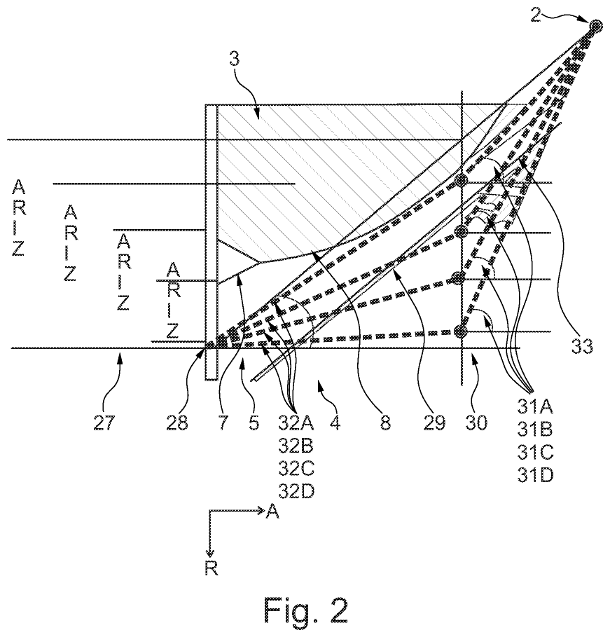

FIG. 2 shows a diagrammatic view of a blade with a crack which begins at the blade leading edge, and with different embodiments of the platform,

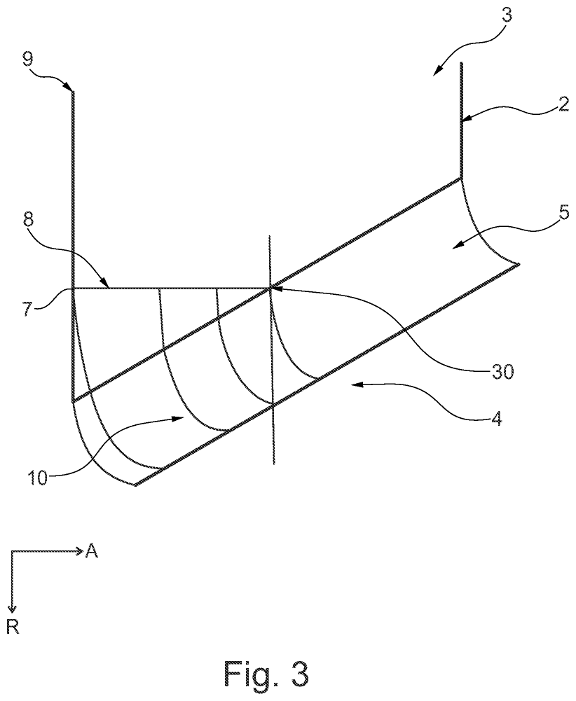

FIG. 3 shows a diagrammatic view of the transition region to the platform with an illustration of elliptical transition radii which are inserted by way of example in the axial direction, and

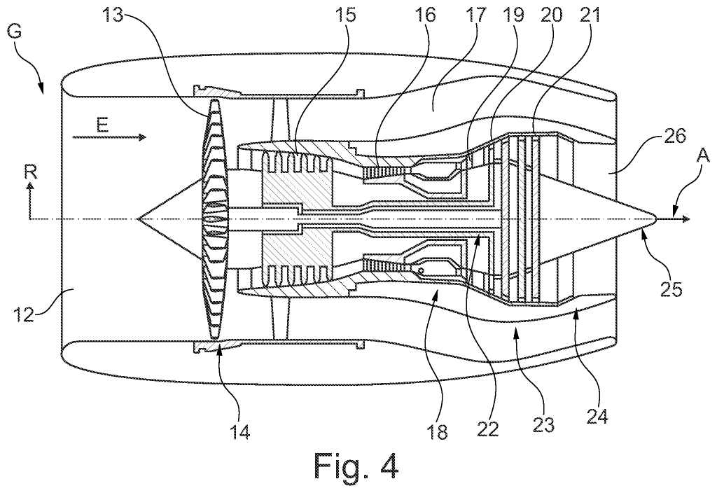

FIG. 4 shows a perspective sectional illustration of a gas turbine.

FIG. 1 shows details of a rotor 11, in order to explain general terms. The rotating body 6 is shown with a platform 4 and a rotor blade 1 which is arranged on the latter and is of integral configuration. The platform 4 forms a radially outer surface of the rotating body 6. The rotating body 6 can be configured as a rotor disc. The platform 4 can therefore be considered to be configured integrally with the rotating body.

The rotor blade 1 has at least one turbine blade 3, a transition region 5 between the platform 4 and the turbine blade 3 being configured between the platform 4 of the rotationally symmetrical rotating body 6, which transition region 5 extends axially from the blade leading edge 9 in a positively locking manner as far as the blade trailing edge 2. A possibly arising crack 7 at the blade leading edge 9 is influenced in terms of its crack growth 8 in the turbine blade 3 by way of the proposed solution, as a result of dynamic loads of the rotating body 6 which occur during operation.

A respective crack 7 propagates from a blade leading edge 9 of the turbine blade 3 as far as a predefined axial fracture crack length 30. The crack 7 which is shown arises at a radial height of the turbine blade 3 in relation to the radial axis R of the engine which is arranged radially outside a critical height 35, the critical height 35 being configured such that it is free from crack growth 8. By way of the provision of a critical height 35, at which no crack growth 8 takes place, a minimum radial height of the rotor blade 1 can be defined, at which a crack 7 can begin to grow. As a result, the radial spacing from the transition region 5 and from the platform for is also defined. A crack growth 8 radially above the critical height 35 can be tolerated, since even snapping of a turbine blade 3 does not result in any critical failure of the gas turbine G (FIG. 4).

The crack growth 8 is subject to different phases. Here, in a first phase, the crack 7 grows horizontally, that is to say substantially parallel to the engine longitudinal axis A. In a second phase, the crack deviates and grows substantially parallel to the angle of attack 31A to D (FIG. 2) of the platform 4. In this way, the rotor is designed in such a way that, in the case of a crack 7 occurring at the minimum radial height, the crack 7 in every case transfers into the second phase of the crack growth 8 or already achieves fracture toughness before the transition region 5 is reached. If the crack propagated beyond the transition region 5 as far as into the rotating body 6, a critical failure of the rotating body 6 can occur during operation of the gas turbine G on account of circumferential stresses. The reference sign 27 identifies an interaction zone, within which a crack which begins there would propagate into the rotating body 6 and would lead to a failure of the rotating body 6.

FIG. 2 shows a common illustration of different angles of attack and the resulting interaction zones (Airfoil Rotor Interaction Zone, ARIZ) 27. In each case four different angles of attack for in each case a first and a second section are illustrated diagrammatically using dashed lines. The angles of attack 32A to D of the first section 29 and the angles of attack 31A to D of the second section 33 of the platform 4 are of rectilinear configuration in their respective extent. That is to say, the radius of the outer surface of the platform 4 rises in the axial direction. The respective angles of attack 32A to D and 31A to D can also in each case be of discontinuous configuration, however, and can rise in each case in the axial direction in the first and/or second section 29, 33.

According to the invention, the platform has a first section 29 and a second section 33, an angle of attack 32A to D of the first section 29 being smaller than an angle of attack 31A to D of the second section. The angles of attack 32A to D, 31A to D are measured with respect to the engine longitudinal axis A. In the embodiment which is shown here, the angle of attack 32A to D of the first section 29 is plotted at an intersection point 28 of the blade leading edge 9 of the turbine blade 3 with the platform 4 in the region of the transition region 5, The first section 29 extends as far as the axial fracture crack length 30. The respective angles of attack 31A to D of the second section 33 of the respective design variants are plotted at a respective intersection point of a ray of the respective angles of attack 32A to D of the first section 29 with the axial fracture crack length 30. The second section 33 extends between the axial fracture crack length 30 and the blade trailing edge 2. The axial fracture crack length 30 denotes an axial region of the turbine blade 1, in which the crack 7 reaches the fracture toughness of the material.

It is shown that the crack growth 8 is subject to different phases. Here, in a first phase, the crack 7 grows horizontally, that is to say substantially parallel to the engine longitudinal axis A. In a second phase, the crack 7 deviates and grows substantially parallel to the angle of attack of the platform 4 or along a stress curve which is set as a result of the operating conditions. During the crack growth 8, the crack stress rises at the crack leading edge until the crack stress exceeds the fracture toughness of the material, at which the crack propagation speed is as it were infinite and the crack 7 grows suddenly as far as the blade trailing edge 2 of the rotor blade 1, and the rotor blade 1 is detached from the rotor. In the exemplary embodiment which is shown here, this takes place when the axial fracture crack length 30 is reached. On account of the smaller angle of attack of the platform 4 in the first section 32A to D in comparison with the second section 31A to D, the crack 7 is given more space and time before the crack 7 reaches the transition region 5 between the rotor blade 1 and the platform 4. On account of the higher presence of material in the transition region 5, the stress is lower in the transition region 5 than in the turbine blade 4, with the result that a crack which propagates in the turbine blade 3 and reaches fracture toughness before the transition region 5 is reached will not propagate into the transition region 5.

FIG. 2 shows the prior art by way of the upper solid line which extends from the intersection point 28 to the blade trailing edge 2. In the first section 29, the crack propagates approximately parallel to the engine longitudinal axis A. The crack 7 already grows into the transition region 5 during the horizontal propagation of the crack 7. As a result, the crack 7 can propagate into the rotor disc and can lead to a failure of the rotor and the engine. In this case, the interactions and 27 is of substantially maximum configuration and is delimited by way of the upper ARIZ line.

In order to clarify the influence of the angle of attack of the platform on the crack growth 8 in comparison with the prior art, four design variants of the respective angles of attack 32A to 32D and 31A to 31D are additionally illustrated. In a first design variant which is shown by way of the uppermost dashed line, the angle of attack 32A in the first section 29 of the platform 4 is of slightly flatter configuration than in the prior art. As a result, the transition region 5 in the first section 29 is also of flatter configuration. This leads to the crack 7 growing up to the transition region 5, but no longer growing into the transition region 5. When the axial fracture crack length 30 is reached, the crack 7 has already entered into phase II of the crack growth 8 and has deviated. The angle of attack 31A of the second section 33 of the first design variant is of steeper configuration than in the prior art and than the angle of attack 32A of the first section 29. This is possible, since the crack 7 has already deviated and follows the stress curve in the turbine blade 3 along the beginning of the transition region 5. In addition, the slight flattening of the angle of attack 32A in the first section 29 leads to a considerable reduction of the interaction region 27, shown by way of the second ARIZ line from the top.

The further design variants with angles of attack 32B and 32C which become flatter in the first section 29 of the platform 4 and steeper angles of attack 31B and 31C in the second section 33 illustrate the significant influence of the angle of attack 32B and 32C of flat configuration of the platform 4. The flatter angles of attack 32B and 320 prevent that the crack 7 grows into the transition region 5. As a result, the interaction zone 27 can in each case be of smaller configuration. Moreover, the crack 7 already deviates in the turbine blade 3 and runs away from the transition region 5, without growing into the transition region 5.

The angle of attack 32D of the first section 29 of the fourth design variant is configured substantially with 0 degrees, and has the smallest interaction zone 27 in relation to the prior art and the other design variants. In this case, the crack growth 8 is situated far above the transition region 5, since the crack 7 grows parallel to the transition region 5 and deviates or reaches the fracture toughness before it can grow into the transition region 5.

It is therefore provided for the transition region 5 between the rotor blade 1 and the platform 4 to be kept away from the crack 7 during the first phase of the crack growth 8, in which the crack 7 propagates substantially horizontally, by the transition region 5 being configured radially below the horizontal crack growth 8. This is achieved by way of the smaller angles of attack 32A to D in the first section of the platform 4.

The interaction zones 27 of the respective angles of attack which are shown vary in terms of theft size. The interaction zone 27 describes a zone, in which a crack which begins in this zone would grow into the transition region 5 and finally into the rotating body 6. The interaction zone is delimited in each case by way of the lower line, with respect to which the respective angles of attack 32A to D are measured, and by way of a respective upper boundary line. The smaller the angle of attack 32A to D of the first section 29 in relation to the engine longitudinal axis A, the smaller the interaction zone 27 of the crack 7. The first section 29 is delimited in its axial extent by way of the axial fracture crack length 30. When the axial fracture crack length 30 is reached, the crack 7 has already entered into the second phase of the crack growth 8 and has deviated in the opposite radial direction with respect to the radial axis R and runs in the direction of the blade trailing edge 2.

FIG. 3 diagrammatically shows a further detailed design variant, further details in the transition region 5 being shown in addition to FIG. 2. In order to additionally reduce the tensile stresses at the blade leading edge 9, a transition radius 10 is configured in the transition region 5 between a respective turbine blade 3 and the platform 4, the transition radius 10 having an elliptical or circular course. The transition radius 10 runs within the interaction zone 27 here. The transition radius 10 is of maximum configuration at the blade leading edge 9, and decreases with the axial length. As a result, the tensile stress which occurs during operation at the blade leading edge 9 and in the transition region 5 is minimized, and the crack growth 8 is delayed. Therefore, the crack 7 is forced rather to deviate before it can grow into the transition region 5 or before the fracture toughness is reached. As a result, the interaction zone 27 is additionally decreased further.

FIG. 4 shows a gas turbine G diagrammatically and in a sectional illustration. Engine components are arranged behind one another along an engine longitudinal axis A of the gas turbine G, Air is sucked in along an inlet direction E at the inlet 12 by means of a fan 13. This fan 13 is situated in a fan housing 14 and is driven by a turbine 23 via a rotor shaft 22, The turbine 23 adjoins a compressor which has a low-pressure compressor 15, a high-pressure compressor 16 and possibly also a medium-pressure compressor. For thrust generation, the fan 13 supplies the low-pressure compressor 15, the high-pressure compressor 16 and the bypass channel 17 with air. A main flow which runs through the core of the gas turbine G and an auxiliary flow which runs through the bypass channel 17 are therefore produced. The air which is compressed in the compressor 15, 16 is mixed with fuel and burned in the combustion chamber 18. The turbine 23 which can consist of a high-pressure turbine 19, possibly a medium-pressure turbine 20 and a low-pressure turbine 21 is driven by way of the hot gas which is produced. The energy released during the combustion is used by the turbine 23 to drive a rotor shaft 22 and therefore to drive the fan 13, in order then to generate the required thrust via the air which is conveyed into the bypass channel 17. Both the auxiliary flow from the bypass channel 17 and the main flow flow out via an outlet 26. Here, the outlet 26 usually has a thrust nozzle with a centrally arranged outlet cone 25. For noise mitigation, a mixer as part of a mixer group 24 is situated in the region of the outlet. As a result of the special contour of the mixture, the main flow from the core flow and the auxiliary flow from the bypass channel 17 of the gas turbine G are diverted and mixed in such a way that the turbulences which arise in the process lower the audible noise level. The proposed solution can also be used in the case of gas turbines of different configuration, for example in any desired type of gas turbine engine such as, for example, in the case of an open rotor or a turboprop engine or a geared turbofan.

### LIST OF REFERENCE SIGNS

1 Rotor blade
2 Blade trailing edge
3 Turbine blade
4 Platform
10 Transition region
6 Rotating body
7 Crack
8 Crack growth
9 Blade leading edge
10 Transition radius
11 Rotor
12 Inlet
13 Fan
14 Fan housing
15 Low-pressure compressor
16 High-pressure compressor
17 Bypass channel
18 Combustion chamber
19 High-pressure turbine
20 Medium-pressure turbine
21 Low-pressure turbine
22 Rotor shaft
23 Turbine
24 Mixer group
Outlet cone
26 Outlet
27 Interaction zone (Airfoil Rotor Interaction Zone, ARIZ)
28 Intersection point
29 First section
30 Axial fracture crack length
31A Angle of attack, second section, first design variant
31B Angle of attack, second section, second design variant
31C Angle of attack, second section, third design variant
31D Angle of attack, second section, fourth design variant
32A Angle of attack, first section, first design variant
32B Angle of attack, first section, second design variant
32C Angle of attack, first section, third design variant
32D Angle of attack, first section, fourth design variant
33 Second section
35 Critical height
E Inlet direction
A Engine longitudinal axis
R Radial axis
G Gas turbine

1. A rotor of a gas turbine comprising at least one rotating body with a platform and a multiplicity of rotor blades arranged thereon, having at least one turbine blade, the platform of the rotating body having a first section and a second section which are oriented at a respective angle of attack with respect to the engine longitudinal axis, and the respective rotor blades are subject to a crack growth in the state in which they are installed as intended into an engine, a respective crack spreading from a leading edge of the turbine blade as far as a predefined axial fracture crack length, at which blade fracture occurs,
wherein
the first section has a smaller angle of attack than the second section, the first section extending from a leading edge of the platform as far as the axial fracture crack length.

2. The rotor according to claim 1, wherein the respective crack arises at a radial height of the turbine blade which is arranged radially outside a critical height, the critical height being configured such that it is free from crack growth.

3. The rotor according to claim 1, wherein the platform is configured with a discontinuous angle of attack profile with respect to the engine longitudinal axis in such a way that the angle of attack of the first and/or the second section of the platform rises in the axial direction.

4. The rotor according to claim 1, wherein the angle of attack of the first section of the platform has a value of substantially 0 degrees in the region of the leading edge.

5. The rotor according to claim 1, wherein the turbine blade is configured with a blade material which has a fracture toughness, at which blade failure occurs, the axial fracture crack length denoting an axial length of the turbine blade, at which the crack reaches the fracture toughness of the blade material.

6. The rotor according to claim 1, wherein the first section of the platform is configured substantially in the range of from 0% to 50% of the axial length of the platform.

7. The rotor according to claim 1, wherein a transition radius is configured between a respective turbine blade and the platform, the transition radius having an elliptical or circular course.

8. The rotor according to claim 7, wherein the transition radius is at a maximum at the leading edge of the turbine blade, and decreases with an axial length in the first section of the platform.

9. A method for producing a rotor comprising the steps:
providing a rotating body with a platform and a multiplicity of rotor blades arranged thereon comprising a turbine blade,
calculating an axial fracture crack length of a crack in the turbine blade,
determining a first section of the platform and a second section of the platform,
wherein
an angle of attack of the first section of the platform with respect to an engine longitudinal axis is smaller than an angle of attack of the second section of the platform with respect to the engine longitudinal axis, the first section extending from a leading edge of the platform as far as the axial fracture crack length.

10. The method according to claim 9, comprising, furthermore, the step:
calculating a critical height of the rotor blade which adjoins the platform radially on the outside, the critical height defining a region which is configured such that it is free from crack growth.

11. The method according to claim 9, wherein the platform is configured with a discontinuous angle of attack profile with respect to the engine longitudinal axis in such a way that the angle of attack of the first and/or second section of the platform rises in the axial direction.

12. The method according to claim 9, wherein the angle of attack of the first section of the platform has a value of substantially 0 degrees in the region of the leading edge.

13. The method according to claim 9, wherein the turbine blade is configured with a blade material which has a fracture toughness, at which blade failure occurs, the axial fracture crack length denoting an axial length of the turbine blade, at which the crack reaches the fracture toughness of the blade material.

14. The method according to claim 9, wherein the first section of the platform is configured substantially in the region of from 0 to 50% of the axial length of the platform.

15. The method according to claim 9, wherein a transition radius is configured between a respective turbine blade and the platform, the transition radius having an elliptical or circular course.

16. The method according to claim 9, wherein the radius is at a maximum at a turbine blade leading edge, and decreases with an axial length in the first section of the platform.
